(19) United States
(12) Patent Application Publication
(10) Pub. No.: US 2024/0145879 A1
(43) Pub. Date: May 2, 2024

(54) ELECTRIC STORAGE DEVICE

(71) Applicant: Prime Planet Energy & Solutions, Inc., Tokyo (JP)

(72) Inventors: Kaito KARASUNO, Kakogawa-shi (JP); Hiroshi TAKABAYASHI, Koriyama-shi (JP)

(21) Appl. No.: 18/490,753

(22) Filed: Oct. 20, 2023

(30) Foreign Application Priority Data
Oct. 28, 2022 (JP) 2022-173421

(51) Int. Cl. H01M 50/54; H01M 10/658; H01M 50/103; H01M 50/627

(52) U.S. Cl. CPC H01M 50/54; H01M 10/658; H01M 50/103; H01M 50/627

(57) ABSTRACT

Provided is a technique suppressing an electrode assembly inside an outer case from moving in a vertical direction with a simple configuration. An electric storage device includes the electrode assembly, the outer case, a sealing plate, a current collector, and an insulating member. The electrode assembly includes a tab. The outer case includes a bottom surface and an opening opposed to the bottom surface, and is a member accommodating the electrode assembly inside. The sealing plate covers the opening. The current collector is attached to the sealing plate, and is electrically connected to the electrode assembly via the tab. The insulating member is arranged between the sealing plate and the current collector. In addition, the insulating member includes an extension part configured to extend toward the electrode assembly so as to press the electrode assembly onto the bottom surface.

### CROSS REFERENCE TO RELATED APPLICATIONS

The present application claims the priority based on Japanese Patent Application No. 2022-173421 filed on Oct. 28, 2022, the entire contents of which are incorporated in the present specification by reference.

### BACKGROUND OF THE DISCLOSURE

### 1. Technical Field

A present disclosure relates to an electric storage device.

### 2. Background

Japanese Patent Application Publication No. 2019-129129 discloses an electric storage apparatus that includes an electrode assembly, an outer case configured to accommodate the electrode assembly, a cover configured to cover the outer case, and an electrode terminal. The cover of the electric storage apparatus described above is provided with a liquid injection hole configured for performing a liquid injection of an electrolytic solution into the outer case. The cover is provided with a cylinder body that is configured to extend from the cover toward the electrode assembly so as to surround an opening of the liquid injection hole on a surface of the cover at an electrode assembly side. Then, the cylinder body described above includes a shielding part configured to couple with the cylinder body and disposed between the liquid injection hole and the electrode assembly. This cited document describes that it is possible by including the shielding part to reduce a flow velocity of the electrolytic solution when the electrolytic solution injected into the outer case collides with the electrode assembly. Then, it describes that it is possible by this to suppress a material of the electrode assembly from being damaged, peeled off, and fallen.

In this cited document, the cover is provided with a current collector configured to electrically connect the electrode assembly and the electrode terminal. The current collector is provided with a penetration hole, and the cylinder body is inserted into the penetration hole. For connecting the electrode assembly and the electrical collector terminal, a tab extending from the electrode assembly is attached to the current collector. At that time, a tip end of the tab is opposed to a side surface of the cylinder body inserted into the penetration hole. An electric storage apparatus of this cited document includes two electrode assemblies, and the cylinder body is sandwiched between the tab extending from one of the electrode assemblies and the tab extending from the other one of the electrode assemblies.

### SUMMARY

Anyway, regarding the electric storage device having a configuration in which the electrode tab is arranged at the cover side, a space might be formed between a sealing plate and a top end surface of the electrode assembly. In that case, when a vibration or an impact is applied on the electric storage device, the electrode assembly inside the outer case becomes easily moved in a vertical direction. The present inventor is thinking to use a simple configuration so as to suppress the movement of the electrode assembly inside the outer case in the vertical direction.

The herein disclosed electric storage device includes an electrode assembly including an electrode tab, an outer case including a bottom surface and an opening opposed to the bottom surface and being configured to accommodate the electrode assembly inside, a sealing plate being configured to cover the opening, a current collector being attached to the sealing plate and being electrically connected to the electrode assembly via the electrode tab, and an insulating member arranged between the sealing plate and the current collector. The insulating member includes an extension part being configured to extend toward the electrode assembly and being configured to press the electrode assembly onto the bottom surface.

In accordance with such a configuration, by making the insulating member include the extension part as described above, it is possible to use a simple configuration so as to suppress the electrode assembly inside the outer case from moving in a vertical direction.

In a preferable aspect of the herein disclosed electric storage device, the extension part is inclined from the insulating member toward the electrode assembly. A tip end of the extension part comes into contact with a center area containing an intersection point at which a center line in a long side direction of a top end surface of the electrode assembly and a center line in a short side direction of the top end surface cross. In accordance with such a configuration, it is possible to enhance the above described effect.

In another preferable aspect of the herein disclosed electric storage device, the extension part is in an approximately rectangular plate shape. The extension part includes a straight portion disposed at a tip end and two bent portions respectively disposed at both ends of the straight portion. In accordance with such a configuration, it is possible to enhance the above described effect. It is also possible to implement an effect of suppressing the electrode assembly from being damaged by the extension part.

In another preferable aspect of the herein disclosed electric storage device, the tip end of the extension part comprises an R shape at a contact portion with the electrode assembly. In accordance with such a configuration, it is possible to further enhance the above-described electrode assembly damage suppressing effect.

In another preferable aspect of the herein disclosed electric storage device, regarding the extension part, a contact portion with the electrode assembly is configured with a resin material being softer than a different portion excluding the contact portion. In accordance with such a configuration, it is possible to further enhance the above-described electrode assembly damage suppressing effect.

In another preferable aspect of the herein disclosed electric storage device, the extension part includes a boss at a surface at a side of the electrode assembly on an area excluding the tip end, the boss protruding toward the electrode assembly. According to such a configuration, it is possible, in addition to the effect of the herein disclosed technique, to enhance a rigidity of the extension part.

The electric storage device may include an electrolytic solution, and includes a liquid injection hole that is provided on the sealing plate to inject the electrolytic solution into the outer case. The extension part may be disposed between the liquid injection hole and the electrode assembly. In accordance with such a configuration, it is possible, in addition to the effect of the herein disclosed technique, to suppress the electrode assembly from being damaged by the injected electrolytic solution.

### BRIEF DESCRIPTION OF THE DRAWINGS

FIG. 1 is a cross section view of an electric storage device 100.

FIG. 2 is a II-II cross section view of FIG. 1.

FIG. 3 is a perspective view of a first insulating member 91.

FIG. 4 is a plan view of an electrode assembly 20.

FIG. 5 is a side view of a first insulating member 291.

FIG. 6 is a side view of a first insulating member 391.

### DESCRIPTION OF THE EMBODIMENTS

Below, an embodiment of a herein disclosed electric storage device will be explained. The embodiment explained here is, of course, not intended to particularly restrict a herein disclosed technique. The herein disclosed technique is not restricted to the herein explained embodiment, unless specifically mentioned. Each figure is schematically drawn, and thus might not always reflect the real one. Members/portions contributing in the same effect are suitably provided with the same reference sign, and an overlapping explanation might be omitted. A wording “A to B” representing a numerical value range might mean “equal to or more than A and not more than B” and might semantically cover “more than A and less than B”, unless specifically mentioned.

In the present specification, a term “electric storage device” means a device that induces charging and discharging by making charge carriers move between a pair of electrodes (positive electrode and negative electrode) via an electrolyte. The electric storage device described above semantically covers a secondary battery, such as lithium ion secondary battery, nickel hydrogen battery, and nickel cadmium battery; and a capacitor, such as lithium ion capacitor and electric double layer capacitor. Below, as an example of the above described electric storage device, an embodiment in which the lithium ion secondary battery is set to be a target will be described.

### First Embodiment

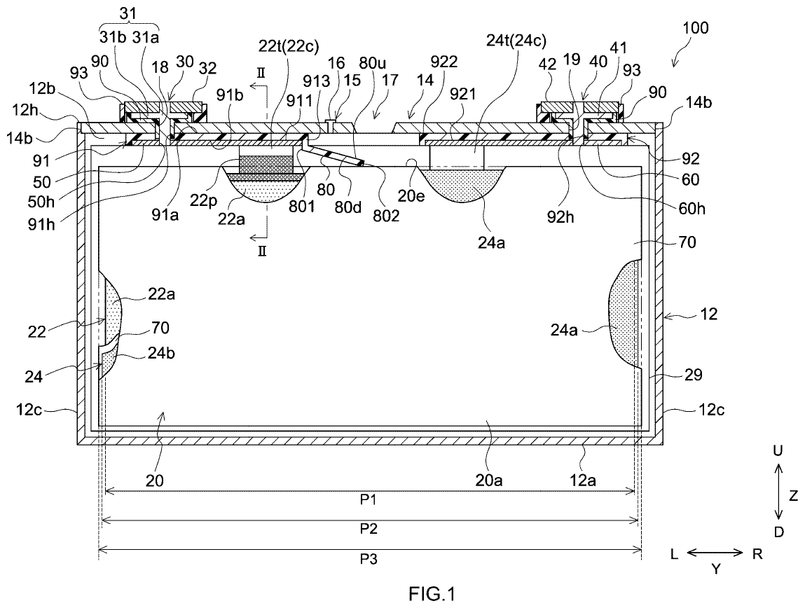

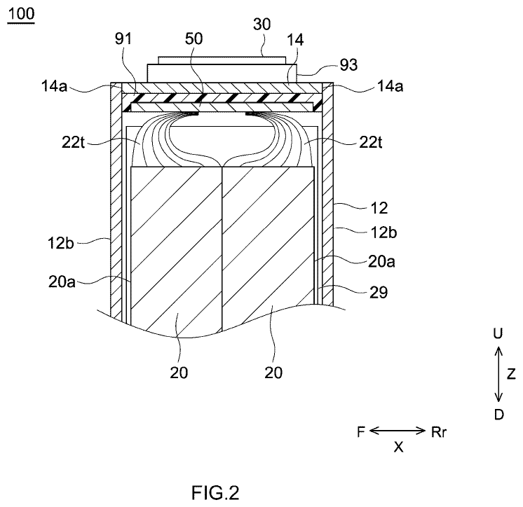

FIG. 1 is a cross section view of an electric storage device 100. FIG. 2 is a II-II cross section view of FIG. 1. FIG. 1 shows a state in which an inside is exposed along a wide width surface 12b of an outer case 12 of the electric storage device 100. FIG. 2 shows a state in which the inside is exposed along a narrow width surface 12c of the outer case 12 of the electric storage device 100. Incidentally, reference signs L, R, U, D, F, and Rr in figures respectively represent left, right, up, down, front, and rear. In figures, a reference sign X represents a short side direction of the electric storage device 100, a reference sign Y represents a long side direction of the electric storage device 100, and a reference sign Z represents a vertical direction (height direction) of the electric storage device 100. However, these are merely directions for convenient explanation, which never restrict the disposed form of the electric storage device 100.

As shown in FIG. 1 and FIG. 2, the electric storage device 100 includes an outer case 12, a sealing plate 14, an electrode assembly 20, a positive electrode terminal 30, a negative electrode terminal 40, a positive electrode current collector 50, a negative electrode current collector 60, and members having an insulating property. The electric storage device 100 herein is a lithium ion secondary battery. As the illustration is omitted, the electric storage device 100 herein further includes an electrolytic solution.

The outer case 12 is, for example, a housing configured to accommodate the electrode assembly 20. The outer case 12 includes, as shown in FIG. 1 and FIG. 2, an opening 12h, a bottom surface 12a, a pair of wide width surfaces 12b, and a pair of narrow width surfaces 12c. In this embodiment, the bottom surface 12a is in an approximately rectangular shape, and is opposed to the opening 12h. The pair of wide width surfaces 12b are configured to extend from a pair of opposed long sides of the bottom surface 12a. The pair of narrow width surfaces 12c are configured to extend from a pair of opposed short sides of the bottom surface 12a. In this embodiment, an area size of the wide width surface 12b is larger than an area size of the narrow width surface 12c. The opening 12h is in an approximately rectangular shape, and is attached to the sealing plate 14. Then, by making the sealing plate 14 be joined to a circumferential edge of the opening 12h, the outer case 12 and the sealing plate 14 are integrated so as to be airtightly sealed.

The sealing plate 14 is, for example, a member in a flat plate shape to close the opening 12h. The sealing plate 14 is, for example, enough to be in a shape corresponding to a shape of the opening 12h. In this embodiment, the sealing plate 14 is in an approximately rectangular shape. The sealing plate 14 includes, as shown in FIG. 1 and FIG. 2, a pair of long side parts 14a opposed to each other and a pair of short side parts 14b opposed to each other. In FIG. 1, the pair of short side parts 14b are respectively arranged at a left end part and a right end part. As shown in FIG. 1, the sealing plate 14 is, for example, provided with a liquid injection hole 15 and an exhaust valve 17. The liquid injection hole 15 is for injecting the electrolytic solution into the outer case 12 after the sealing plate 14 is assembled to the outer case 12. The liquid injection hole 15 is sealed by a sealing member 16. The exhaust valve 17 is a thin-walled part that is configured to be broken, when a pressure inside the outer case 12 after sealing becomes equal to or more than a predetermined value, so as to exhaust the inside gas to the outside.

The electrode assembly 20 is, for example, a power generating element of the electric storage device 100. As shown in FIG. 2, the electric storage device 100 includes two electrode assemblies 20 that are arranged adjacent to each other. These adjacent two electrode assemblies 20 are, as shown in FIG. 1 and FIG. 2, accommodated in the outer case 12 under a state of being covered by an electrode assembly holder 29. As shown in FIG. 1, the electrode assembly 20 includes a positive electrode plate 22 in a rectangular sheet shape, a negative electrode plate 24 in a rectangular sheet shape, and a separator 70 configured to work as a separator. The positive electrode plate 22 and the negative electrode plate 24 have laminate structures in which electrode plates are laminated via the separators 70. Here, regarding the electrode assembly 20, a so-called laminate type electrode assembly is illustrated in which the positive electrode plates 22 and the negative electrode plates 24, each in a predetermined shape, are overlaid while the separators 70 are disposed between them.

The positive electrode plate 22 includes, as shown in FIG. 1, a positive electrode current collecting foil 22c in an approximately rectangular shape, and a positive electrode active material layer 22a formed on the positive electrode current collecting foil 22c. The positive electrode active material layers 22a are respectively formed on both side surfaces of the positive electrode current collecting foil 22c. In this embodiment, a formation area of the positive electrode active material layer 22a is in a rectangular shape. The positive electrode plate 22 includes a positive electrode tab 22t configured to protrude from one side of the formation area of the positive electrode active material layer 22a. The positive electrode tab 22t is a part of the positive electrode current collecting foil 22c, and is an unformed part where the positive electrode active material layer 22a is not formed on the surface. In this embodiment, a positive electrode protective layer 22p is formed at a boundary between the positive electrode active material layer 22a and the positive electrode tab 22t. The positive electrode protective layer 22p herein is formed at an end part of the positive electrode active material layer 22a in a protruding direction of the positive electrode tab 22t, and is disposed adjacent to the positive electrode tab 22t. Incidentally, it is not essential to form the positive electrode protective layer 22p.

As the positive electrode current collecting foil 22c, it is possible, for example, to use an aluminum foil. The positive electrode active material layer 22a is a layer containing a positive electrode active material. The positive electrode active material is, for example, a material like a lithium transition metal composite material for the lithium ion secondary battery, which can release a lithium ion at an electrically charging time and can absorb the lithium ion at an electrically discharging time. As the positive electrode active material, various materials other than the lithium transition metal composite material are generally proposed, which is not particularly restricted. The positive electrode protective layer 22p is, for example, a layer containing an inorganic filler, such as alumina.

The negative electrode plate 24 includes, as shown in FIG. 1, a negative electrode current collecting foil 24c in an approximately rectangular shape and a negative electrode active material layer 24a formed on the negative electrode current collecting foil 24c. The negative electrode active material layers 24a are respectively formed on both side surfaces of the negative electrode current collecting foil 24c. In this embodiment, a formation area of the negative electrode active material layer 24a is in a rectangular shape. The negative electrode plate 24 includes a negative electrode tab 24t configured to protrude from one side of the formation area of the negative electrode active material layer 24a described above. The negative electrode tab 24t is a part of the negative electrode current collecting foil 24c, and is an unformed part where the negative electrode active material layer 24a is not formed on the surface.

As the negative electrode current collecting foil 24c, it is possible, for example, to use a copper foil. The negative electrode active material layer 24a is a layer containing a negative electrode active material. The negative electrode active material is, for example, a material like a natural graphite for the lithium ion secondary battery, which can store the lithium ion at the electrically charging time and can release the lithium ion, stored at the electrically charging time, at the electrically discharging time. As the negative electrode active material, various materials other than the natural graphite are generally proposed, which is not particularly restricted.

The separator 70 is in an approximately rectangular shape on this embodiment, and is formed one size larger than the negative electrode active material layer 24a to implement covering the negative electrode active material layer 24a. As the separator 70, for example, a porous resin sheet is used through which an electrolyte having a necessary heat resistant property can pass. As the separator 70, various materials are proposed, which is not particularly restricted.

As shown in FIG. 1, a width P2 of the negative electrode active material layer 24a in a long side direction of the bottom surface 12a is longer than a width P1 of the positive electrode active material layer 22a in the same direction. A width P3 of the separator 70 in the long side direction of the bottom surface 12a is longer than the width P2 of the negative electrode active material layer 24a. The positive electrode tab 22t and the negative electrode tab 24t have necessary lengths so as to protrude from the separator 70. The positive electrode plate 22, the negative electrode plate 24, and the separator 70 are, as shown in FIG. 1, overlaid so as to make the negative electrode active material layer 24a cover the positive electrode active material layer 22a in a state where the separator 70 is disposed between them, and to make the positive electrode tab 22t and the negative electrode tab 24t protrude from the separator 70. In this embodiment, on a rectangular area formed by making the positive electrode plate 22 and the negative electrode plate 24 be overlaid via the separator 70, the positive electrode active material layers 22a are formed on the both surfaces of the positive electrode plate 22 and the negative electrode active material layers 24a are formed on the both surfaces of the negative electrode plate 24. At one of end parts (here, top end surface 20e of the electrode assembly 20) of the above described rectangular area, plural positive electrode tabs 22t protrude in a state of being superimposed. At the above described one of end parts, plural negative electrode tabs 24t protrude in a state of being superimposed.

Regarding the electrode assembly 20, as shown in FIG. 1 and FIG. 2, a body excluding the positive electrode tab 22t and the negative electrode tab 24t is in a flat rectangular parallelepiped shape having a pair of wide width rectangular surfaces 20a. In this embodiment, end surfaces of each electrode plate and the separator 70 in a laminate direction (direction X in FIG. 2) configure the wide width rectangular surface 20a. Regarding the above described body, 4 side surfaces excluding the pair of wide width rectangular surfaces 20a are laminate surfaces with the positive electrode plate 22, the negative electrode plate 24, and the separator 70.

The positive electrode terminal 30 is, for example, a member electrically connected to the positive electrode plate 22 of the electrode assembly 20. As shown in FIG. 1, the positive electrode terminal 30 is inserted into a terminal taking out hole 18 so as to be exposed on an outer surface of the sealing plate 14. Here, the positive electrode terminal 30 includes a first conductive member 31 and a second conductive member 32. The first conductive member 31 includes a shaft part 31a and a base part 31b. The shaft part 31a is, for example, in a cylindrical shape, is inserted into penetration holes of the terminal taking out hole 18 and the second conductive member 32, and is inserted into a penetration hole 50h of the positive electrode current collector 50. The base part 31b is, for example, in a flat plate shape, and is arranged along an outer surface of the sealing plate 14. Regarding a formation shown in FIG. 1, the second conductive member 32 is, for example, in a flat plate shape, and is arranged along the outer surface of the sealing plate 14. The first conductive member 31 and the second conductive member 32 are mutually connected at an outer surface side of the sealing plate 14. The first conductive member 31 can be, for example, configured with aluminum or aluminum alloy. The second conductive member 32 can be, for example, configured with aluminum, aluminum alloy, copper, copper alloy, or the like.

The negative electrode terminal 40 is, for example, a member electrically connected to the negative electrode plate 24 of the electrode assembly 20. As shown in FIG. 1, the negative electrode terminal 40 is inserted into a terminal taking out hole 19 so as to be exposed on the outer surface of the sealing plate 14. Here, the negative electrode terminal 40 includes a first conductive member 41 and a second conductive member 42. The first conductive member 41 can be, for example, configured with copper or copper alloy. Further, the negative electrode terminal 40 can have a configuration similar to the positive electrode terminal 30. Thus, explanation about the configuration of the negative electrode terminal 40 is omitted, here.

The positive electrode current collector 50 is, for example, a member electrically connected to the electrode assembly 20 via the plural overlaid positive electrode tabs 22t. The positive electrode current collector 50 is, for example, a conductive member in a rectangular flat plate shape. On the formation shown by FIG. 1, the positive electrode current collector 50 is configured to extend along an inner surface of the sealing plate 14. On the formation shown by FIG. 1, the positive electrode current collector 50 is attached to the sealing plate 14, not to overlap with the liquid injection hole 15. The positive electrode current collector 50 includes the penetration hole 50h. Into the penetration hole 50h, the positive electrode terminal 30 is inserted. To the positive electrode current collector 50, plural overlaid positive electrode tabs 22t are joined. The positive electrode current collector 50 can be, for example, configured with aluminum or aluminum alloy.

The negative electrode current collector 60 is, for example, a member electrically connected to the electrode assembly 20 via the plural overlaid negative electrode tabs 24t. The negative electrode current collector 60 is, for example, a conductive member in a rectangular flat plate shape. On the formation shown by FIG. 1, the negative electrode current collector 60 is configured to extend along an inner surface of the sealing plate 14. On the formation shown by FIG. 1, the negative electrode current collector 60 is attached to the sealing plate 14, not to overlap with the liquid injection hole 15. The negative electrode current collector 60 includes a penetration hole 60h. Into the penetration hole 60h, the negative electrode terminal 40 is inserted. To the negative electrode current collector 60, the plural overlaid negative electrode tabs 24t are joined. The negative electrode current collector 60 can be, for example, configured with copper or copper alloy.

On the electric storage device 100, various members each having the insulating property are used. The electric storage device 100 is configured, for example, to include the electrode assembly holder 29, a gasket 90, first insulating members 91, 92, and a second insulating member 93 (see FIG. 1 and FIG. 2). The electrode assembly holder 29 is, for example, a member for inhibiting conduction between the electrode assembly 20 and the outer case 12. Here, the electrode assembly 20 is arranged inside the outer case 12 under a state of being covered with the electrode assembly holder 29. The electrode assembly holder 29 consists, for example, of a resin sheet having an insulating property.

The gasket 90 and the second insulating member 93 are, for example, members respectively configured to inhibit conduction between the positive electrode terminal 30 and the sealing plate 14 and inhibit conduction between the negative electrode terminal 40 and the sealing plate 14. The gasket 90 herein is arranged between the first conductive member 31 at the positive electrode side and the outer surface of the sealing plate 14 and between the first conductive member 41 at the negative electrode side and the outer surface of the sealing plate 14. The gasket 90 is attached between an inner periphery of the terminal taking out hole 18 and an inner periphery of the terminal taking out hole 19. The second insulating member 93 herein is arranged between the second conductive member 32 at the positive electrode side and the outer surface of the sealing plate 14, and between the second conductive member 42 at the negative electrode side and the outer surface of the sealing plate 14.

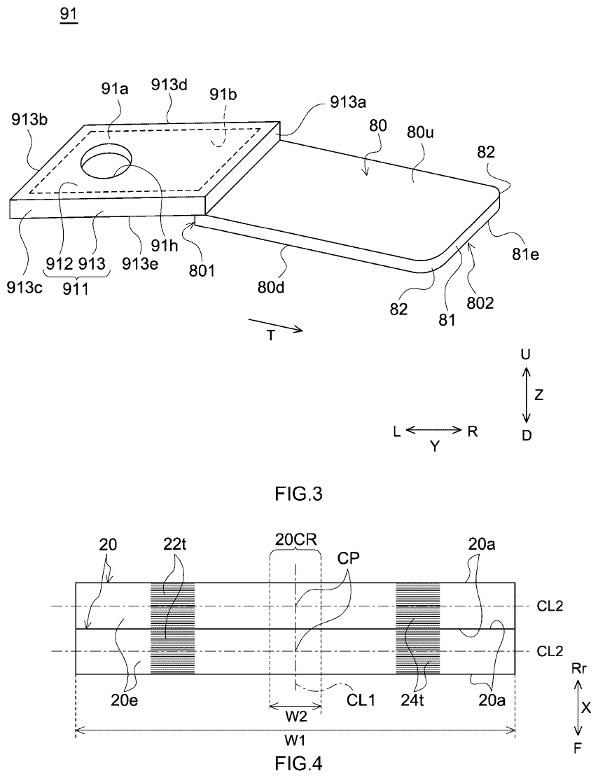

FIG. 3 is a perspective view of the first insulating member 91. FIG. 3 shows a perspective view of the first insulating member 91 viewed from a first surface 91a at the sealing plate 14 side in FIG. 1. The first insulating member 91 is, for example, a member configured to inhibit conduction between the positive electrode current collector 50 and the sealing plate 14. The first insulating member 91 herein is arranged between the positive electrode current collector 50 and the inner surface of the sealing plate 14. As shown in FIG. 1 and FIG. 3, the first insulating member 91 includes a body 911 and an extension part 80. The body 911 is, for example, a portion arranged between the sealing plate 14 and the positive electrode current collector 50. As shown in FIG. 3, the body 911 includes a flat part 912 and a wall part 913. The flat part 912 is, for example, in a rectangular flat plate shape and is a portion on which the positive electrode current collector 50 is arranged. On the formation shown by FIG. 1, the flat part 912 is attached to the inner surface of the sealing plate 14 under a state where the first surface 91a is disposed at the inner surface side of the sealing plate 14 and a second surface 91b is disposed at the electrode assembly side. Here, the positive electrode current collector 50 is arranged on the second surface 91b. The second surface 91b in FIG. 1 is a surface at a side opposite to the first surface 91a and a surface at a side of the electrode assembly 20 accommodated in the outer case 12. The flat part 912 herein includes the penetration hole 91h. Regarding arrangement of the positive electrode current collector 50 on the flat part 912, for example, the penetration hole 50h of the positive electrode current collector 50 is overlaid with the penetration hole 91h. Into the penetration hole 91h, for example, a part of the gasket 90 is inserted.

The wall part 913 is, for example, a portion configured to surround a circumferential edge of the positive electrode current collector 50 arranged on the flat part 912 (here, second surface 91b). As shown in FIG. 1 and FIG. 3, the wall part 913 is configured to extend from the circumferential edge of the flat part 912 (here, circumferential edge of the second surface 91b). On the formation shown by FIG. 1, the wall part 913 is configured to extend toward the electrode assembly 20. As shown in FIG. 3, the wall part 913 includes a pair of opposed first wall parts 913a, 913b, and a pair of opposed second wall parts 913c, 913d. The first wall parts 913a, 913b are, for example, approximately parallel to the short side parts 14b of the sealing plate 14. The first wall part 913a is, for example, arranged at a center side (liquid injection hole 15 side in FIG. 1) of the sealing plate 14 (see FIG. 1). The first wall part 913b is, for example, arranged at a left side end part of the sealing plate 14 (see FIG. 1). The second wall parts 913c, 913d are, for example, approximately parallel to the long side parts 14a of the sealing plate 14. The second wall part 913c is, for example, arranged at a near side of the sealing plate 14 (not shown in figures). The second wall part 913d is, for example, arranged at a far side of the sealing plate 14 (not shown in figures).

An extending end 913e of the wall part 913 is provided with the extension part 80. Here, the extension part 80 is provided on the extending end 913e of the first wall part 913a. In this embodiment, the body 911 of the first insulating member 91 is formed integrally with the extension part 80. Regarding the first insulating member 91, by providing the extension part 80 configured to extend from the body 911, it is possible to omit using a different member provided for attaching the extension part 80. Incidentally, the first insulating member 91 is an example of “insulating member” of the herein disclosed electric storage device.

The extension part 80 herein is a portion configured to press the electrode assembly 20 onto a bottom surface 12a. In this embodiment, the extension part 80 is configured to extend toward the electrode assembly 20. As shown in FIG. 3, the extension part 80 is configured to be inclined with respect to the flat part 912 so as to extend. An extending direction of the extension part 80 is shown by an arrow T in FIG. 3. In a below described explanation, the direction described above might be referred to as simply “extending direction T”. The extending direction T herein is a direction directed from a base end 801 of the extension part 80 toward a tip end 802. Incidentally, on the formation shown by FIG. 1, an upper surface 80u of the extension part 80 is opposed to an inner surface of the sealing plate 14. A lower surface 80d of the extension part 80 is opposed to the top end surface 20e of the electrode assembly 20. The upper surface 80u and the lower surface 80d in this embodiment are flat surfaces on which a protruding part, a recessed part, and the like are not provided.

As shown in FIG. 1, the extension part 80 is inclined from the first insulating member 91 (here, body 911) toward the electrode assembly 20. In the present specification, the phrase “the extension part 80 is inclined toward the electrode assembly 20” means that an angle defined by the extension part 80 and the top end surface 20e of the electrode assembly 20 (below, simply referred to as “inclined angle of the extension part 80”, too) is larger than 10 degrees. The top end surface 20e of the electrode assembly 20 is, for example, a surface opposed to the inner surface of the sealing plate 14. The top end surface 20e herein is a surface on which the electrode tab is provided. An inclined angle of the extension part 80 is approximately equal to or less than 45 degrees, or the inclined angle may be, for example, equal to or less than 40 degrees, equal to or less than 30 degrees, equal to or less than 20 degrees, or, equal to or less than 15 degrees. By making the extension part 80 be inclined toward the electrode assembly 20, it is possible to reach the tip end 802 of the extension part 80 to a target portion of the electrode assembly 20 by the shortest distance from the body 911. Thus, it is possible to make the extension part 80 be more compact.

FIG. 4 is a plan view of the electrode assembly 20. FIG. 4 shows the top end surfaces 20e of two electrode assemblies 20 whose wide width rectangular surfaces 20a are arranged in an opposed manner to each other. On the formation shown by FIG. 4, the tip end 802 of the extension part 80 comes into contact with a center area 20CR of the top end surface 20e of the electrode assembly 20. The center area 20CR herein is an area including an intersection point (center point) CP at which a center line CL1 in the long side direction of the top end surface 20e and a center line CL2 in the short side direction of the top end surface 20e cross to each other. A width W2 of the center area 20CR in the long side direction of the top end surface 20e may be approximately ⅛ to ¼ (for example, ⅙ to ⅕) with respect to a width W1 in the long side direction of the top end surface 20e. Although it is preferable that the center point CP of the top end surface 20e coincides with a center point (not shown in figures) of the center area 20CR, it might not coincide if the effect of the herein disclosed technique is implemented. By making the tip end 802 of the extension part 80 come into contact with the center area 20CR of the top end surface 20e, it is possible to further stably press the electrode assembly 20 when the extension part 80 presses the electrode assembly 20. It is also possible to decrease a risk that the electrode assembly 20 is fallen down by the press described above. Thus, it is possible to suppress the electrode assembly 20 inside the outer case 12 from moving in the vertical direction.

On the formation shown by FIG. 1, the extension part 80 is disposed between the liquid injection hole 15 and the electrode assembly 20. In that case, the upper surface 80u of the extension part 80 receives the electrolytic solution injected from the liquid injection hole 15 so as to work as a flow channel of the electrolytic solution. By this, it is possible to suppress the injected electrolytic solution from directly coming into contact with the electrode assembly 20. Thus, it is possible to suppress the inside of the electrode assembly 20 from being damaged by the impact due to the injected electrolytic solution.

On the formation shown by FIG. 3, the extension part 80 is in an approximately rectangular plate shape. The extension part 80 includes a straight portion 81 at the tip end 802 and two bent portions 82. These two bent portions 82 are respectively arranged at both ends of the straight portion 81. As shown in FIG. 3, the bent portion 82 is bent toward the outer side. Here, the whole of a lower border 81e of the straight portion 81 (border of the straight portion 81 at the lower surface 80d side) comes into contact with the top end surface 20e of the electrode assembly 20. By making the extension part 80 include the straight portion 81 at the tip end 802, it is possible to increase a range where the tip end 802 and the top end surface 20e come into contact with each other. Thus, it is possible to further suitably suppress the electrode assembly 20 inside the outer case 12 from moving in the vertical direction. It is also possible to disperse the pressure applied to the top end surface 20e. Furthermore, by providing the bent portions 82 respectively on both ends of the straight portion 81, corner parts are removed from the tip end 802. By this, it is possible to decrease the risk that the top end surface 20e of the electrode assembly 20 is damaged by the contact with the extension part 80.

Although not particularly restricting, it is preferable that the tip end 802 of the extension part 80 has an R shape at a contact portion with the electrode assembly 20. In this embodiment, it is preferable that R chamfering is performed on a lower border 81e of the straight portion 81. By this, it is possible to decrease the risk that the top end surface 20e of the electrode assembly 20 is damaged by contact with the extension part 80. Alternatively, from a similar perspective, the tip end 802 and the top end surface 20e might come into contact with each other. In that case, that chamfering (for example, C chamfering) may be performed on the lower border 81e of the straight portion 81. By implementing surface contact of the portion of the lower border 81e of the straight portion 81, subjected to chamfering, with the top end surface 20e, it is possible to disperse the pressure applied on the top end surface 20e.

A material configuring the extension part 80 is, for example, a resin material. The extension part 80 might be, for example, configured with one kind of resin material, or might be configured with 2 or more kinds of resin materials. For example, regarding the extension part 80, the contact portion with the electrode assembly 20 might be configured with a resin material softer than a different portion excluding the contact portion. In that case, for example, the extension part 80 may have a two-layer structure including a top layer at the upper surface 80u side and a bottom layer at the lower surface 80d side. For example, a bottom layer may be configured with a resin material relatively soft and a top layer is configured with a resin material relatively hard. By this, it is possible to decrease the risk that the tip end 802 of the extension part 80 (here, the lower border 81e of the straight portion 81) damages the top end surface 20e of the electrode assembly 20. By configuring a different portion of the extension part 80 with the relatively hard resin material, it is possible to enhance a rigidity of the extension part 80. Incidentally, as the configuration material of the extension part 80, it is possible, for example, to use a synthetic resin material, which is a polyolefin resin, such as polypropylene (PP) and polyethylene (PE); a fluorine resin, such as perfluoroalkoxy alkane and polytetrafluoroethylene (PTFE); or the like. The extension part 80 might be configured with a material the same as the first insulating member 91.

The first insulating member 92 is, for example, a member configured to inhibit conduction between the negative electrode current collector 60 and the sealing plate 14. The first insulating member 92 herein is arranged between the negative electrode current collector 60 and the inner surface of the sealing plate 14. As shown in FIG. 1, the first insulating member 92 includes a penetration hole 92h, a flat part 921, and a wall part 922. The first insulating member 92 herein does not include the extension part 80. About the other things, it includes the same configuration as the first insulating member 91 at the positive electrode side. Thus, explanation about the configuration of the first insulating member 92 herein is omitted.

Materials for configuring the electrode assembly holder 29, the gasket 90, the first insulating members 91, 92, and the second insulating member 93 are not particularly restricted. As the configuration material described above, it is possible to use the above described resin material.

As described above, the electric storage device 100 includes the electrode assembly 20, the outer case 12, the sealing plate 14, the positive electrode current collector 50, and the first insulating member 91. The electrode assembly 20 includes the positive electrode tab 22t. The outer case 12 includes a bottom surface 12a and an opening 12h opposed to the bottom surface 12a, and is a member configured to accommodate the electrode assembly 20. The sealing plate 14 is configured to cover the opening 12h. The positive electrode current collector 50 is attached to the sealing plate 14, and is electrically connected to the electrode assembly 20 via the positive electrode tab 22t. The first insulating member 91 is arranged between the sealing plate 14 and the positive electrode current collector 50. The first insulating member 91 includes the extension part 80 that is configured to extend toward the electrode assembly 20 so as to press the electrode assembly 20 onto the bottom surface 12a.

In the electric storage device 100, the first insulating member 91 is used that includes the extension part 80 configured to press the electrode assembly 20 onto the bottom surface 12a of the outer case 12. Thus, it is possible with a simple configuration to suppress the electrode assembly 20 inside the outer case 12 from moving in the vertical direction.

Although the electric storage device 100 can be used for various purposes, for example, it can be suitably utilized as a power source for motor (power supply for driving) mounted on various vehicles, such as passenger car and truck. Kinds of the vehicle is not particularly restricted, but it is possible to mount it, for example, on a plug-in hybrid electric vehicle (PHEV), a hybrid electric vehicle (HEV), a battery electric vehicle (BEV), or the like.

Above, the embodiment for the herein disclosed technique has been explained, but it is not intended that the herein disclosed technique is restricted to the above described embodiment. The herein disclosed technique can be implemented on another embodiment. The technique recited in the appended claims includes variously deformed or changed versions of the embodiments that have been illustrated above. For example, one part of the above described embodiment can be replaced with another deformed aspect, and furthermore another deformed aspect can be added to the above described embodiment. Unless a technical feature is explained to be essential, this technical feature can be appropriately deleted.

### Second Embodiment

For example, in the first embodiment, the upper surface 80u and the lower surface 80d of the extension part 80 both are flat surfaces. However, the herein disclosed technique is not restricted to this example. FIG. 5 is a side view of a first insulating member 291. On the formation shown by FIG. 5, regarding the first insulating member 291, an extension part 280 is configured to extend from the body 911. On the extension part 280, bosses 281 protruding downwardly are provided on the lower surface 80d of an area excluding the tip end 802. The area excluding the tip end regarding the extension part 280 is, for example, an area positioned at the base end 801 side more than the bent portion 82. By providing the boss 281 on the above described area, it is possible to enhance the rigidity of the extension part 280.

The boss 281 is, in this embodiment, in a cylindrical shape. In FIG. 5, three bosses 281 are provided along the extending direction T. A shape and number of the boss 281 are not particularly restricted, and are suitably set as needed. For example, in another embodiment, bosses in beam shapes are provided along the extending direction T on the lower surface 80d. In this embodiment, the boss 281 is configured not to come into contact with the top end surface 20e of the electrode assembly 20. However, the present discloser is not restricted to this example, from a perspective of further suitably suppressing the electrode assembly 20 inside the outer case 12 from moving in the vertical direction, the boss 281 might be configured to come into contact with the top end surface 20e.

### Another Embodiment

In addition to the effect of suppressing the electrode assembly 20 from moving, from a perspective of suppressing damage generation of the inside of the electrode assembly 20 caused by the injected electrolytic solution, a slit on the upper surfaces 80u of the extension parts 80, 280 can be provided. It is preferable that this slit is, for example, provided along the extending direction T.

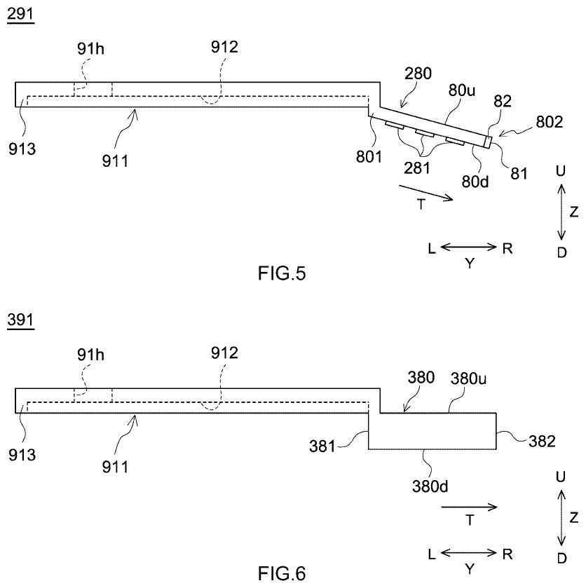

In the first embodiment and the second embodiment, the extension parts 80, 280 are in plate shapes. However, the herein disclosed technique is not restricted to this example. In another embodiment, an extension part in a block shape can be applied. FIG. 6 is a side view of a first insulating member 391. On the formation shown by FIG. 6, regarding the first insulating member 391, an extension part 380 is configured to extend from the body 911. In this embodiment, the extension part 380 is in the block shape. Here, the lower surface 380d is configured to press the top end surface 20e of the electrode assembly 20 onto the bottom surface 12a. By this, it is possible to increase the contact area size with the top end surface 20e, and further possible to apply its own weight of the extension part 380 onto the top end surface 20e. Thus, it is possible to further suitably suppress the electrode assembly 20 inside the outer case 12 from moving in the vertical direction. Incidentally, in FIG. 6, an upper surface 380u of the extension part 380 is a flat surface having no inclination, but the present disclosure is not restricted to this example. For example, the upper surface 380u might be provided with a slit arranged along the extending direction T. Alternatively, the upper surface 380u might be an inclined surface configured to become lower from the base end 381 toward the tip end 382. Incidentally, in FIG. 5 and FIG. 6, a reference sign “912” represents a flat part, a reference sign “913” represents a wall part, and a reference sign “91h” represents a penetration hole.

In the above described embodiment, the extension part 80, the extension part 280, and the extension part 380 are respectively provided at the positive electrode side on the first insulating member 91, the first insulating member 291, and the first insulating member 391. However, the herein disclosed technique is not restricted to this example. The extension part 80, the extension part 280, and the extension part 380 might be provided on the first insulating member 92 at the negative electrode side.

While described above, as a particular aspect for the herein disclosed technique, it is possible to recite about below described items.

Item 1: An electric storage device, comprising:
an electrode assembly that comprises an electrode tab;
an outer case that has a bottom surface and an opening opposed to the bottom surface and that accommodates the electrode assembly inside;
a sealing plate that covers the opening;
a current collector that is attached to the sealing plate and is electrically connected to the electrode assembly via the electrode tab; and
an insulating member that is arranged between the sealing plate and the current collector,

wherein
the insulating member comprises an extension part extending toward the electrode assembly and pressing the electrode assembly onto the bottom surface.

Item 2: The electric storage device recited in item 1, wherein
the extension part is inclined from the insulating member toward the electrode assembly, and
a tip end of the extension part comes into contact with a center area containing an intersection point at which a center line in a long side direction of a top end surface of the electrode assembly and a center line in a short side direction of the top end surface cross to each other.

Item 3: The electric storage device recited in item 1 or 2, wherein
the extension part is in an approximately rectangular plate shape, and
the extension part comprises a straight portion disposed at a tip end and two bent portions respectively disposed at both ends of the straight portion.

Item 4: The electric storage device recited in any one of items 1 to 3, wherein
the tip end of the extension part comprises an R shape at a contact portion with the electrode assembly.

Item 5: The electric storage device recited in any one of items 1 to 4, wherein
regarding the extension part, a contact portion with the electrode assembly is configured with a resin material softer than a different portion excluding the contact portion.

Item 6: The electric storage device recited in any one of items 1 to 5, wherein
the extension part comprises a boss at a surface at a side of the electrode assembly on an area excluding the tip end, the boss protruding toward the electrode assembly.

Item 7: The electric storage device recited in any one of items 1 to 6, further comprising:
an electrolytic solution; and
a liquid injection hole that is provided on the sealing plate and is configured to inject the electrolytic solution into the outer case, wherein
the extension part is disposed between the liquid injection hole and the electrode assembly.

What is claimed is:

1. An electric storage device, comprising:
an electrode assembly that comprises an electrode tab;
an outer case that has a bottom surface and an opening opposed to the bottom surface and that accommodates the electrode assembly inside;
a sealing plate that covers the opening;
a current collector that is attached to the sealing plate and is electrically connected to the electrode assembly via the electrode tab; and
an insulating member that is arranged between the sealing plate and the current collector,
wherein
the insulating member comprises an extension part extending toward the electrode assembly and pressing the electrode assembly onto the bottom surface.

2. The electric storage device according to claim 1, wherein
the extension part is inclined from the insulating member toward the electrode assembly, and
a tip end of the extension part comes into contact with a center area containing an intersection point at which a center line in a long side direction of a top end surface of the electrode assembly and a center line in a short side direction of the top end surface cross to each other.

3. The electric storage device according to claim 2, wherein
the extension part is in an approximately rectangular plate shape, and
the extension part comprises a straight portion disposed at a tip end and two bent portions respectively disposed at both ends of the straight portion.

4. The electric storage device according to claim 3, wherein
the tip end of the extension part comprises an R shape at a contact portion with the electrode assembly.

5. The electric storage device according to claim 1, wherein
regarding the extension part, a contact portion with the electrode assembly is configured with a resin material softer than a different portion excluding the contact portion.

6. The electric storage device according to claim 3, wherein
the extension part comprises a boss at a surface at a side of the electrode assembly on an area excluding the tip end, the boss protruding toward the electrode assembly.

7. The electric storage device according to claim 1, further comprising:
an electrolytic solution; and
a liquid injection hole that is provided on the sealing plate to inject the electrolytic solution into the outer case, wherein
the extension part is disposed between the liquid injection hole and the electrode assembly.
